(19) United States
(12) Patent Application Publication
(10) Pub. No.: US 2010/0218105 A1
(43) Pub. Date: Aug. 26, 2010

(54) Method of browsing and a computer program therefor

(76) Inventors: Sergey Perov, San Francisco, CA (US); Elizabeth Yin, Mountain View, CA (US); Neil Achtman, Mountain View, CA (US); Jennifer Hsieh, Cambridge, MA (US); Dmitry Lesnevsky, Jekabpilcs (LV)

Correspondence Address: Ronald L. Yin, 547 Sullivan Drive, Mountain View, CA, 94041, US

(21) Appl. No.: 12/380,263

(22) Filed: Feb. 26, 2009

(51) Int. Cl. G06F 3/00

(52) U.S. Cl. 715/738

(57) ABSTRACT

A method of browsing a website from the Internet comprises receiving code and/or object from the website from the Internet by a first computer. The code and/or object of the website is transmitted by the first computer to a server computer. The first computer displays the code and/or object of the website at the first computer. The code and/or object of the website received by the server computer is transmitted to a second computer. The code and/or object of the website received by the second computer is displayed at the second computer. The display of the website at the first computer is substantially the same as the display of the website at the second computer.

### TECHNICAL FIELD

The present invention relates to a method of browsing a network of interconnected computer networks, commonly and hereinafter called the “Internet”. The present invention also relates to a computer program therefor.

### BACKGROUND OF THE INVENTION

The Internet is well known in the art. Each computer, or computer network, connected to the Internet has a unique address referred to as a Uniform Resource Locator (URL). A computer, operated by a user, called a client computer typically executes a browser program, such as the Internet Explorer offered by Microsoft Corporation or the Firefox browser offered by the Mozilla Foundation, that allows the client computer to browse the Internet by accessing the various URLs. At each URL, a server computer stores the code and content of the web page (called “object”), that forms the web page displayed by the browser. The server computer responds to the browser from the client computer by supplying the client computer with the necessary code (typically in HTML format) and the objects operated upon by the code. The code and objects, once delivered to the client computer through the Internet is assembled by the web browser program of the client computer into the web page for display on the display device of the client computer.

As the Internet has become more useful in social settings, it is desirable to incorporate the basic browsing experience into a social browsing experience. Thus, for example, it is desirable for a first user at a first client computer operating a web browser program to access a web page from a website to be able to view that same web page from the same website, in real time, with a second user at a second client computer operating another web browser program. In that manner the two users can engage, critique, analyze, or otherwise share comments and/or thoughts with regard to the web page being commonly viewed at the same time. U.S. Pat. No. 5,944,791 and its continuation U.S. Pat. No. 6,263,365 describe a system and a method for browsing the Internet whereby two different users operating two different client computers can view at the same time the same web page thereby share the same browsing experience. Referring to FIG. 1 there is shown a block level diagram of a system 10 of the prior art, such as that disclosed in the aforementioned patents, for collaboratively browsing the Internet 12 in real time. The system 10 comprises a first server computer 14 connected to the Internet 12. Thus, the first server computer 14 is a part of the Internet 12. A first client computer 16 is connected to the first server computer 14, and indirectly connected to the Internet 12. A second client computer 18 is also connected to the first server computer 14 and indirectly connected to the Internet 12. Finally, a second server computer 20 is connected to the Internet 12, and is also a part of the Internet 12. The second server computer 20 contains the web page of interest to the first client computer 16 and the second client computer 18.

When a first user operating the first client computer 16 desires to collaboratively browse the Internet 12 with, e.g. a second user operating the second client computer 18, to a website, such as the website 20, the first client computer 16 issues the URL of the second server computer 20 through the first server computer 14. The first server computer 14 then sends the URL of the second server computer 20 and receives the code and objects of the webpage from the website operated by the second server computer 20 and delivers them to both the first client computer 16 and the second client computer 18, simultaneously.

There are a number of drawbacks to this system and method of the prior art. First, as best understood, the system 10, using a conventional web browser, requires the code and objects from the website 20 to be framed in a frame, i.e. because the first client computer 16 is communicating with the first server computer 14, a first frame of the first server computer 14 is provided, with the website 20 being a second frame within the first frame from the first server computer 14. However, because of so-called “frame-buster” codes that are used by many websites to thwart the framing of their website codes and objects within another frame, when used with a web browser, the system 10 may not function properly at all websites. Second, in the event the first client computer 14 desires to browse to a website that requires, among other elements, log-on, password, or even cookies, the second server computer 20 containing the desired website 20 might not recognize the first server computer 14 as the authorized computer to receive the code and objects from that page of the website. In addition, there may be other problems associated with the system 10 of the prior art, such as latency and synchronization in dealing with Flash and with Ajax in displaying the same web site to both the first client computer 16 and the second client computer 18.

Another method of the prior art to attempt to browse collaboratively is for a first client computer 16 to receive the webpage from the desired URL, and then send the URL as a link to the second client computer 18, in either an email or in a Instant Message (IM). This method has a number of problems. First, the browsing operation is not nearly in real time. Second, it involves the operation and activation of another program, such as email or IM, which can be cumbersome. Third, as the first user of the first client computer 16 changes the URL, a new URL must be supplied to the second user at the second client computer 18 via email or IM, which of course must be retrieved by the second user from the email or IM. Fourth, URLs that require log-on or password or the right session variables and cookies cannot be successfully accessed collaboratively. Finally, Ajax (which will be discussed hereinafter) poses a problem with regard to synchonicity.

It is therefore, one object of the present invention to develop a system, method and computer program to allow co-browsing of the Internet in an efficient and enjoyable experience.

### SUMMARY OF THE INVENTION

Accordingly, in the present invention, a method of browsing a website from the Internet is disclosed. The method comprises receiving code and/or objects from the website from the Internet by a first computer. The code and/or objects of the website is transmitted by the first computer to a server computer. The first computer displays the code and/or objects of the website at the first computer. The code and/or objects of the website received by the server computer is made available to a second computer. The code and/or objects of the website received by the second computer is displayed at the second computer. The display of the website at the first computer is substantially the same as the display of the website at the second computer.

The present invention also relates to a web browser computer program embodied in a machine readable storage medium for execution by a first computer. The web browser computer program comprises computer program code configured to cause the first computer to receive code and/or objects from a website from the Internet. The web browser computer program further comprises computer program code configured to transmit the code and/or objects of the website to a server computer. Finally, the web browser computer program comprises computer program code configured to display the code and/or objects of the website at the first computer.

The present invention also relates to an extension computer program for a web browser computer program which is embodied in a machine readable storage medium for execution by a first computer. The extension computer program comprises computer program code configured to cause the first computer to receive code and/or objects from a website from the Internet. The extension computer program further comprises computer program code configured to transmit the code and/or objects of the website to a server computer. Finally, the extension computer program comprises computer program code configured in conjunction with the web browser computer program to cause the web browser computer program to display the code and/or objects of the website at the first computer.

The present invention also relates to a server computer program embodied in a machine readable storage medium for execution by a server computer. The server computer program comprises computer program code configured to cause the server computer to receive code and/or objects from a first computer, which received the code and/or objects from a website from the Internet. The server computer program further comprises computer program code configured to frame the code and/or objects received in a first frame in a window. The server computer program further comprises computer program code configured to transmit the window to a second computer.

The present invention also relates to a server computer program embodied in a machine readable storage medium for execution by a server computer connected to the Internet. The server computer program comprises computer program code configured to receive instant message chat between a first computer connected to the Internet and for browsing the Internet by accessing a plurality of websites and a second computer, connected to the Internet. The server computer program further comprises computer program code configured to sort the instant message chats between the first computer and said second computer based upon each website browsed by said first computer. Finally, the server computer program comprises computer program code configured to store the sorted instant message chats.

The present invention also relates to a method of browsing a website, having code and/or objects of interest from the Internet. The website has a program code embedded in the code and/or objects. The program code is embodied in a machine readable storage medium for execution by a first computer. The method comprises downloading the program code and the code and/or objects of the website of interest to the first computer. The first computer executes the program code which causes the first computer to transmit the code and/or objects of the website of interest to a server computer. The code and/or objects of the website of interest is displayed at the first computer.

### BRIEF DESCRIPTION OF THE DRAWINGS

FIG. 1 is a schematic diagram of a system of the prior art.

FIG. 2 is a schematic diagram of a system for implementing one embodiment of the method of the present invention.

FIG. 3 is a schematic diagram of a system showing the flow of chat information in accordance with the present invention.

FIG. 4 is a schematic diagram of a screen shot showing the display on the monitor at the second client computer

FIG. 5 is a schematic diagram of the arrangement of chats stored at the server computer

### DETAILED DESCRIPTION OF THE INVENTION

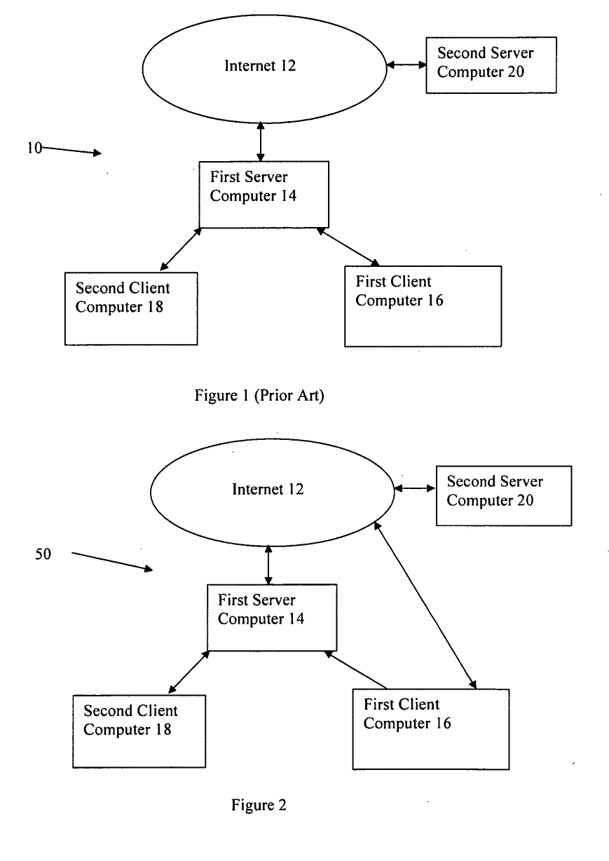

Referring to FIG. 2 there is shown a block level diagram of a system 50 for carrying out the method of the present invention for collaboratively browsing the Internet 12. The system 50 is similar to the system 10, shown in FIG. 1. Hence, like numerals will be used for similar components. The system 50 comprises a first server computer 14 connected to the Internet 12. Thus, the first server computer 14 is a part of the Internet 12. A first client computer 16 is connected to the Internet 12, as well as to the first server computer 14. A second client computer 18 is connected to the first server computer 14. Finally, a second server computer 20 is connected to the Internet 12. The second server computer 20 contains the website of interest.

The first client computer 16 can access the Internet 12 in the usual manner whereby the user (called leader) of the first client computer 16 can browse the Internet 12. Thus, the first client computer executes a well known browser application program such as Internet Explorer or Mozilla's Firefox. However, in the preferred embodiment, the browser application program also executes a browser extension program, which is in the nature of a computer program. In the preferred embodiment, the browser extension is written in well known languages such as XUL, XML, and Javascript for the Firefox browser, and XUL, XML, Javascript and C/C++ for other web browser application programs, such as Safari and Internet Explorer.

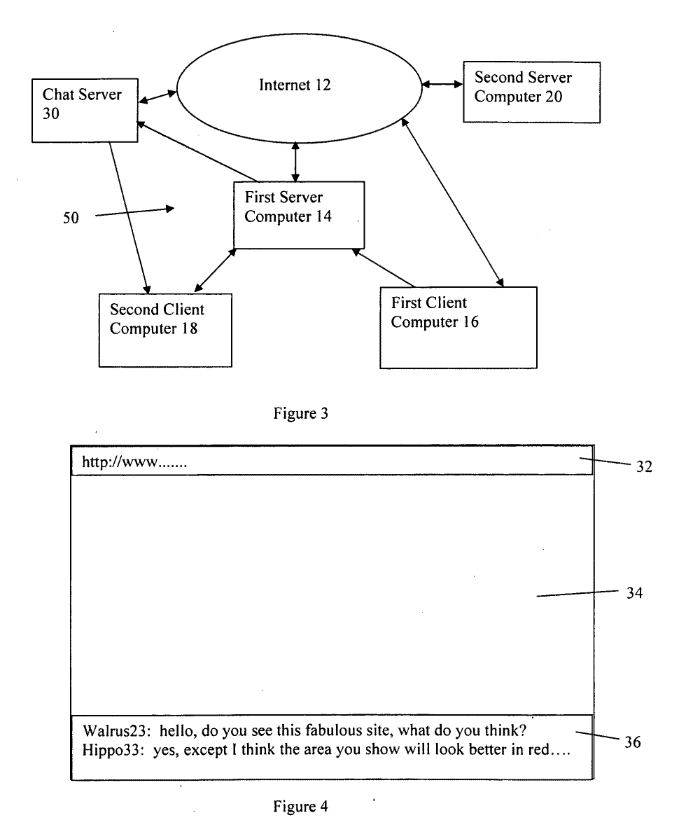

When the leader at the first client computer 16 desires to collaboratively browse the Internet 12 with, a second user (called “follower”) at the second client computer 18, to a website, such as the website 20, the first client computer 16 notifies the first server computer 14 of its desire to “chat” with the Internet address of the second client computer 18. This can be accomplished by the use of conventional initiation with a buddy list in accordance with well known protocol, such as Gmail chat, or ICQ chat or AOL chat. The specifics of how the “chat session” is initiated will be discussed in detail hereinafter. The details of the initiation and execution of the chat session is shown in FIG. 3. Once the chat session is established, and as the browser program of the first client computer 16 accesses the URL of the website 20 directly (or through its ISP—Internet Service Provider) the code and/or objects from the website 20 are received by the first client computer 16. In one embodiment of the present invention, the extension program to the browser program of the present invention at the first client computer 16 causes the code and/or objects received from the website 20 to be automatically sent to the first server computer 14, as they are received, i.e. without waiting for all of the code and/or objects from the entire page to be loaded. The first server computer 14 after receiving the code and/or objects from the first client computer 16 then forwards that code and/or objects to the second client computer 18, which, using its browser program, would then assemble the code and/or objects into a webpage for display on the display device of the second client computer 18. In this manner the web page displayed on the display device of the first client computer 16 is “replicated” on the display device of the second client computer 18. In addition, the code and/or objects received by the first server computer 14 may be stored by the first server computer 14. As will be seen hereinafter, the storage of the code and/or objects by the first server computer 14 facilitates the cobrowsing of web pages when the leader and the follower are not present simultaneously.

A first alternative embodiment of the foregoing can expedite the loading of the webpage from the website 20 at the second client computer 18. As is well known, objects (or content) usually constitutes a large percentage (file size wise) of any web page. Thus, in the event the web page 20 has objects that are from a website that does not require log-in, cookies etc. (“public sites”), rather then sending objects from the first client computer 16 to the first server computer 14 to the second client computer 18, the extension program of the present invention, would send just the code at the website 20 along with a link to the location where the objects for that webpage 20 can be found. This would reduce the time required to transmit the code and/or objects of the webpage 20 of interest to the second client computer 18, through the first server computer 14. Once the second client computer 18 receives the code and/or the link of the objects, it would then retrieve the objects directly from the Internet 20. Moreover, even for a web site that requires log-in, cookies, etc, (“private sites”), if certain objects contained on that web page are from one or more public sites, the links to the public site objects can be transferred from the first client computer 16 to the first server computer 14 to the second client computer 18, thereby reducing the time required for that web page to be displayed at the second client computer 18.

In a second alternative embodiment of the foregoing, when the code and/or objects (or links of objects) of the website 20 is received by the first client computer 16, the extension program to the browser program of the present invention creates a structure of the code and/or objects (or links of objects) of the website 20. The “structure” of a website is similar to a “tree” and is an outline of the state of the display on the first client computer 16. Thus, for example, as will be shown in the discussion below, when a web page 20 contains AJAX code, the source code for that web page 20 will contain code to cover a number of possible states, depending upon user activation. Rather than sending all of the source code covering all the possible states of display, the structure is an outline of the state of the web page that is actually displayed on the display device of the first client computer 16. Thus, the structure is much simplified compared to the source code for the web page. It is an outline of the code that would have been used to create the state of the display shown at the first client computer 16. The structure is then sent to the first server computer 14 where the first server computer 14 uses the structure to re-create another version of the code and/or objects (if objects are sent by the first client computer 16 or the links of the objects, as discussed in the first alternative embodiment), which are sent to the second client computer 18. As is well known, each web browser application program automatically creates a “tree” which is an internal representation of the code and/or objects, that is a specific version of the source code received from the web page 20. The “tree” is the version of the code and/or objects that is the state of the web page actually being displayed. It is created by all web browser application programs in accordance with the Document Object Model standard (a well known public standard). Web application programs need to create a “tree” when a user desires to save the web page that is displayed. After a “tree”, which represents the state of the display is created, the browser extension program of the present invention converts it into a “structure”. In converting a “tree” into a structure, the web browser extension program of the present invention replaces, as needed, the URL of the image tags or objects from a local URL to a universal URL so that the first server computer 14 or the second client computer 18 can access those tags. In addition, links may also need to be changed from local link to universal link.

The advantage of using the code and/or objects (or links of objects) from the website 20 to create a “structure” which is used to re-creates another version of the code and/or objects from the website 20 is as follows. First, as discussed above, rather than supplying all the source code of the web page of interest, by sending a structure of the state of the web page that is actually displayed, far less code is supplied from the first client computer 16 to the server computer 14 to the second client computer 18. Second, in conventional HTML coding (which is the code used to create virtually all webpages), the HTML protocol is not very stringent. A webpage with a missing </HTML> statement may still display properly. However, because the webpage 20 received by the first client computer 16 is manipulated by the first server computer 14 and the first client computer 16 to account for objects such as Ajax or Flash, or to include, e.g. a chat box (as discussed hereinafter), any deviation from standard HTML protocol which might otherwise be tolerated and not be noticed on any display, may not display properly when the code is so manipulated. Third, in the event AJAX is used, the use of a structure ensures synchronicity between what is displayed on the display of the first client computer 16 with the display on the second client computer 18. Therefore, to ensure that the manipulated code (and objects) from the website 20 is properly displayed at the display device of the second client computer 18, in the preferred embodiment, the HTML code from the website 20 is first converted into a structure from which stringent HTML standard protocol code are then re-created. Thus, as used herein, and especially in the claims, the reference to “code and/or objects” from the website 20 being received by the first client computer 16, and transferred from the first client computer 16 to the first server computer 14, and transferred to the second client computer 18 includes the transfer of 1) code and/or one or more objects from the website 20 directly; and/or 2) code and/or links of one or more objects from the website 20; and/or 3) the conversion of code and/or one or more objects into a structure which then re-creates a version of the code and/or one or more objects.

Apart from the foregoing to expedite the communication process between the first client computer 16 and the second client computer 18 with regard to the transmission of the code and/or objects from the website 20, any of the following may be additionally done.

First, as discussed above, without waiting for the entire webpage of code and/or objects to be received, and then displayed on the display device associated with the first client computer 16, the extension program of the present invention can capture the tree of the web page displayed as generated by the web browser application program and then use the tree to create a structure sent to the first server computer 14. Once the first server computer 14 has this structure, it can then re-create the web page for the second client computer 18 causing the second client computer to get objects directly from the original source, when possible. Thus, for websites with a large amount of objects or objects that are large in size, this allows the second client computer 18 to fetch the objects directly from the Internet 12 potentially fetching objects in parallel with the first client computer 16. Once the displayed page is displayed, and as further code and/or objects are received by the first client computer 16, the extension program would then create the structure of the subsequent displayed portion of the web page. Thus, as the follower is viewing the displayed page, the code and/or objects within the same webpage but after the displayed portion may be operated upon, without the follower feeling the web browsing experience is slow. In the event the follower at the second client computer 18 “scrolls” down the displayed page past the displayed portion of the web page 20, then the first server computer 14 would have already transmitted the subsequent portion of the web page 20.

Second, once the structure is created, the program to generate the code and/or objects (or links of objects) from the structure of the website 20 can create more efficient code and/or objects, thereby decreasing the size of the file thereby increasing the subsequent speed of transmission from the first server computer 14 to the second client computer 18. One example of reformatting is to eliminate unnecessary code and/or objects received. Another example is that extra blank spaces in the code and/or objects may be eliminated.

Third, if the second client computer 18 also has the browser extension program of the present invention, the browser extension program can include well known compression programs (such as zip program). Thus, the first server computer 14 may be able to send compressed web files to the second client computer 18, with the web extension program enabling to de-compresses the file to retrieve the re-created code and/or objects from the website 20.

As previously discussed, one of the potential problems of the prior art device 10 shown in FIG. 1 is in dealing with problems such as latency and synchronization associated with Flash or Ajax objects used in the website 20. We shall consider the problem of Flash, first.

A Flash object, as is well known, can be simply a video file. However, a Flash object can also constitute a plurality of images that represent different states within the same web page from a URL. Thus, depending upon the state of that webpage, a display of the webpage at one client computer may differ from the display of that webpage at another client computer, even though both have received the same code and/or objects from the same URL. In the method and program of the present invention, the web extension program of the present invention operating at the first client computer 16 takes a still image of the webpage from the website 20 containing the Flash object. The location of the Flash object within the still image taken is determined, and is then cut out of the still image. Then an image of the Flash object at the desired state is taken and is then inserted into the cut out, which is the location of the Flash object.

With regard to AJAX, which is also well known, AJAX is code and/or objects within a web page that alters the display of the web page depending on user input (such as by clicking of a pointing device such as a mouse, or by entering alphanumeric characters, etc.) without requiring the webpage to reload from the website 20. The difficulty presented by AJAX code is in knowing what is displayed on the display device of the first client computer 16, when the same URL is presented at both the first client computer 16 and the second client computer 18. The method and program of the present invention solves the AJAX problem in the following manner. The web extension program of the present invention, at the first client computer 16 recreates the structure of the changed state of the display, and transmits that changed structure to the first server computer 14, which then re-creates the code and forwards it to the second client computer 16. In the event the leader at the first client computer 16 changes the display by user input through either the clicking of a pointing device, such as a mouse or by entering alphanumeric characters, another changed structure is created and is then transmitted to the first server computer 14, and then to the second client computer 18. In this manner, synchronization between the display at the display devices of the first client computer 16 and the second client computer 18 is maintained.

To further enhance the collaborative browsing experience, as is well known, the first client computer 16 may have a pointing device, such as a mouse associated therewith. In general the mouse is also an event changing device. As the mouse is used to click various links, it can change the events in the displayed webpage. The location and therefore, the movement of the tracking device, is tracked by the browser extension program of the present invention executing at the first client computer 16. That information is conveyed to the first server computer 14. The first server computer 14 then conveys that information to the second client computer 18. This can be accomplished, e.g. by the first server computer 14 “painting” a portion of the web page displayed on the display of the second client computer 18, in the same location as the location of the tracking device on the first client computer 16. The “painting” can be done by coloring of portions of the web page or by other indicia.

As noted above, when the leader at the first client computer 16 initiates a co-browsing session, the leader initiates a “chat” session. Referring to FIG. 3, there is shown a schematic diagram of a system showing the flow of chat information in accordance with the present invention. At the outset, it is assumed that the leader has a “chat” account at any of the well known chat providers, such AIM, GTalk, Yahoo IM, ICQ, etc., each of which resides on a chat server 30. The “chat” is commenced by the leader at the first client computer 16 activating or clicking a “share” or other indicia “button which may be located on the toolbar section of the browser. The activation of the “share” button, causes the web extension program of the present invention to “call” the first server computer 14 and initiate a log-in at the first server computer 14 (assuming that the leader has not already logged in, since it is possible for the leader to log in once and to be kept logged in). Assuming that the leader has not already logged in at the first server computer 14, a tabbed window overlaying the browsed window on the display device associated with the first client computer 16, appears. The leader is asked to provide information in the tabbed window which includes the leader's user name, password, and the domain of the chat server 30 that the leader has a chat account with, such as AOL, GTalk, Yahoo IM, ICQ, etc. The tabbed window also includes one or more pull down menus including the “chat buddy” list, which the web extension program of the present invention has retrieved from the first client computer 16. The “chat buddy” list may be combined from multiple “buddy lists” from different chat accounts, such as AOL, GTalk etc. The leader selects the name of the “buddy” (follower) that he/she wants to chat with by highlighting the name, and then clicking the “invite” button.

Upon the clicking of the “invite” button, the name of the follower along with the leader's chat name, password, and the identity of the chat domain are sent to the first server computer 14. The first server computer 14 then initiates a chat session with the chat server 30, by supplying the requisite user name of the leader, his/her password and identity of the buddy invited to chat. Thus, to the chat server 30, it is as if the first server computer 14 is trying to log in to initiate a chat. The first server computer 14 further supplies the chat server 30 an invitation to co-browse for the buddy selected. Once the leader's name, and password, and identity of the buddy are verified by the chat server 30, the chat server 30 sends the invitation message to the second client computer 18. In the event the follower (invited buddy) at the second client computer 18 accepts the invitation to co-browse, by clicking on the link provided in the invitation from the chat server 30, the link clicked by the follower, establishes a communication link between the second client computer 18 and the first server computer 14.

Once communication is established between the first server computer 14 and the second client computer 18, the web page which is being viewed by the first client computer 16 is sent in the manner described above, to the first server computer 14. However, as previously discussed, at the first client computer 16, the browsed page is shown in a first window, with the chat with the follower at the second client computer 18 in a separate second window. At the second client computer 18, however, the web page that is delivered from the first server computer 14 is displayed in a first content block of the display, while the chat is displayed in a second, separate content block of the window.

Referring to FIG. 4 there is shown schematic a diagram of a screen shot showing the display on the monitor at the second client computer 18. The display shown in FIG. 4 is of a single window, and comprises the URL of the first server computer 14 shown in a first displayed portion 32, a portion of the web page 20 that is browsed by the first client computer 16 shown in a second display portion 34, and a separate chat content displayed in a third display portion 36.

Collectively, the second content block 34 and the third content block 36 are displayed in the same active window. In this manner, when the follower browses the page 20 and desires to chat with the leader, the follower simply has to move to a separate portion of the window. With the chat in the same window as the browsed page data, the chat communication is thereby directly transferred between the first client computer 16 and the second client computer 18 through the first server computer 14. Thus, the first server computer 14 can capture and store the chat data. In addition, since the chat data is associated with a particular browsed page, in another aspect of the present invention, the chat data is stored in association with a particular URL or address of the browsed site. Furthermore, since the initial establishment of the chat occurred through the first server computer 14 to the chat server 30, the first server computer 14 knows the screen name of the leader using the first client computer 16 and the screen name of the follower using the second client computer 18. Thus, as shown in the third portion 36, the leader's screen name is Walrus23, while the follower's screen name is Hippo33. With the screen name displayed in the third portion 36, the chatting experience for the leader and the follower is no different than a conventional chat session routed through the chat server 30.

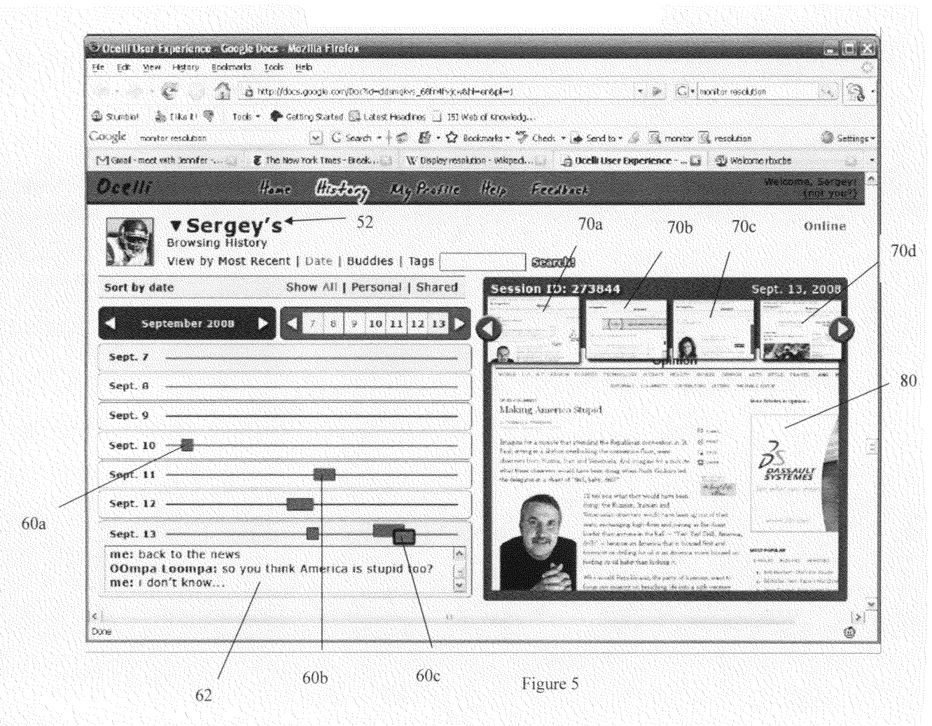

Referring to FIG. 5, there is shown an example of a screen shot of a stored history of co-browse and chat session. The identity of the leader 52 or the owner of the co-browse and chat history is shown. In addition, a plurality of co-browse sessions 60(a-c) are shown in a calendar timeline, with each co-browse session 60 shown as a box. Each co-browse box 60 can be highlighted, with each co-browse session 60 further subdivided into a plurality of co-browsed pages, with a chat associated with each co-browsed page. Thus for example, once a co-browse session 60, e.g. 60c, is clicked, a plurality of mini-web pages 70(a-d) showing the web pages that were co-browsed during that co-browsing session 60c are shown on the display. The user can select the webpage 70, e.g. 70a, that was co-browsed to view the details of that co-browsed web page 70a. Once the web page 70a of interest is highlighted, it is displayed in a larger image format 80. If image 80 is selected, the page will further enlarge to the full screen. Further, the chat associated with that co-browsed web page 70a is then displayed in a separate content block 62. As can be seen, chats are associated with webpages and are organized by this association, not with the co-browse session as a whole, and therefore chats are displayed when their associated webpages are highlighted. In contrast, in the chats of the prior art, chats are stored by time only. Furthermore, because the web pages 70(a-d) that were co-browsed or attempted to be co-browsed are stored, in the event, a leader initiates a chat session and the follower is not present or available at that time, the follower can subsequently log into the first server computer 14 to access both the attempted co-browse page(s) 70, as well as the chat from the leader describing the particular points of interest on those web page(s) 70. In this manner “off-line” co-browsing can occur.

In yet another embodiment of the present invention, the method of the present invention can be accomplished by having an activatable icon (such as a “start” button) positioned on the web page 20 which is browsed by the leader using the first client computer 16. Initially, when the web page 20 is retrieved by the leader operating the first client computer 16, among the code and/or objects downloaded from the webpage is a javascript code for execution by the first client computer 16. In addition, the webpage 20 is formed of two parts: a second display portion 34, and a third display portion 36. Initially, the second display portion 34 fills the entire display area on the display device (except for the first display portion 32, which is generated by the browser of the first client computer 16) of the first client computer 16, and contains the content from the web page 20. The third display portion 36 is configured to display zero portion on the display device of the first client computer 16, and contains no content. Thus, the third display portion 36 is “hidden” by the second display portion 34.

When the leader desires to share or co-browse the web page 20, the leader simply activates or clicks the “start” button on the web page 20. The activation of the “start” button causes the first client computer 16 to execute the downloaded javascript code. The downloaded javascript code functions in ways similar to the extension program to the web browser discussed heretofore. The execution of the javascript code causes the second display portion 34 to be reduced in size and with the third display portion 36 to be increased in size, such that the two display portions 34 and 36 are displayed together on the display device of the first client computer 16. In addition, the execution of the javascript causes the “buddy lists” from the first client computer 16 to be displayed in the third display portion 36.

When the leader enters the data to initiate a chat session, the data is then sent by the javascript code to the first server computer 14. Similar to the procedure described above for the initiation of chat, the first server computer 14 contacts the chat server 30 and provides the name and password for the leader as entered in the third display portion 36 to log into the chat server 30. Thereafter once logged in, the first sever computer 14 provides the identity of the “buddy” (follower), which was provided by the leader in the third display portion 36, to whom the leader desires to share the web page 20. The first server computer 14 then enters the identity of the follower in the chat server 30. The chat server 30 then opens a chat window at the display of the second client computer 18, with an invitation from the leader to “co-browse”. Once the follower “accepts” by clicking the accept button or link, that response is sent to the first server computer 14, which then communicates to the webpage server 20, establishing the chat communication link.

Similar to the function of the browser extension program described heretofore, the javascript code can send the code and/or objects of the web page 20, or can send the code and/or a link of the objects of the web page, or can create a structure of the displayed page from the content displayed in the second display portion 34 and send the structure to the first server computer 14. In the same manner, the first server computer 14 then re-creates code and/or objects from the structure and sends that re-created code and/or objects to the second client computer 18 for display on the display device.

The javascript code that is loaded with the content from the web server 20 also monitors the state of the display on the display device of the first client computer 16. Thus, in the event AJAX code is contained in the web page 20 and the leader changes the state of the display by activating one or more icons or buttons, the javascript would create a new structure and send that structure to the first server computer 14.

With respect to Flash, the javascript at the first client computer 14 informs the first server computer 14 the location of the object and the second client computer 18 can retrieve directly the Flash object to be placed in the web page.

A variation of the foregoing is that in the event the javascript code is a large file, some or all of the javascript code may not be loaded with the web page 20 when it is initially retrieved. Some or all of the javascript code file may be “downloaded” to the first client computer 16 only after the ‘start” button is activated. Since not all users accessing the web page 20 may desire to co-browse, the “downloading” of the javascript code only after the “start” button is activated means that those users who do not co-browse, would not experience any delay in viewing the web page 20.

From the foregoing it can be seen that the yet another embodiment of the present invention, in which the method of the present invention is accomplished by having an activatable icon (such as a “start” button) placed on the web page 20 which is browsed by the leader using the first client computer 16, and in which a javascript is downloaded to the first client computer 16, this embodiment of the method can be used in any website 20 that is being browsed. In particular, in this embodiment, the method can be practiced with any private network within the Internet 12, such as social network site, such as Myspace or Facebook etc., in which network has an application platform that permits the installation of javascript code. In that event, when the user (either a leader or a follower) is logged into the private network, the user can participate in the co-browsing experience without leaving the private network. Furthermore, the first server computer 14 may also be integrated with the second server computer 20 that contains the browsed website 20. Thus, with this embodiment, co-browsing by users logged into a private network can be experienced by the user without leaving the private network.

There are many variations of the present invention possible. For example, in an alternative embodiment, the chat between the first client computer 16 and the second client computer 18 is not limited to instant messaging chat. The chat can also be VOIP (Voice Over IP), or even video chat. As previously discussed, the foregoing method and program is well suited to deal with the display of content (code and/or object) from a private web site that requires log-in, cookies, etc, as well as public websites that do not require log-in, cookies etc. In the event the first client computer 16 is displaying content from a public site, the web extension program of the present invention may simply transmit the URL of the public site to the first server computer 14, which retrieves the content and sends them to the second client computer 18. For private sites, the web extension program of the present invention may permit the user at the first client computer 16 to transmit the cookie and log-in information to the first server computer 14 and to the second client computer 18, thereby permitting the first server computer 14 to retrieve content directly from the private sites for downloading to the second client computer 18.

In addition to the foregoing, other variations of the method and program of the present invention are as follows. First, when the leader at the first client computer 16 begins co-browsing and initiates the chat session, the second client computer 18 may respond to the first client computer 16 notifying it that it is starting to co-browse. In addition, when the second client computer 18 receives the content of the webpage of interest from the first server computer 14, the second client computer 18 may notify the first client computer 16 that it has received the content of the webpage of interest. In addition, in the event when the leader at the first client computer 16 commences the co-browsing activity and the follower is not at the second client computer 18 or the second client computer 18 is not turned on, the webpage that is of interest is stored at the first server computer 14 along with the messages transmitted by the leader to the follower. In this manner, when the follower later returns to the second client computer 18 or the second client computer 18 is turned on, the follower can retrieve the web page as well as the chat message(s) transmitted by the leader. Further, because all the web pages and chats of a session are stored on the first server computer 14, a history of the co-browsing activity of the leader is stored on the first server computer 14 for subsequent retrieval and review.

There are many applications of the method and program of the present invention. First, the program can be a separate extension of a browser, or it can be integrated into a web browser program. Second, the program need not even reside at the first client computer 16. AS described above, the program of the present invention can reside at the website 20. In that event, when the leader at the first client computer 16 browses the Internet 12, using a conventional browser, and reaches the website 20, the leader user can “click” a start or other indicia to initiate the program of the present invention.

What is claimed is:

1. A method of browsing a website from a network of interconnected computer networks (“Internet”) comprising:
receiving code and/or objects from the website from the Internet by a first computer;
transmitting said code and/or objects of said website by said first computer to a server computer;
displaying said code and/or objects of said website at said first computer;
making available said code and/or objects of said website by said server computer to a second computer; and
displaying said code and/or objects of said website at said second computer;
wherein the display of said website at said first computer is substantially the same as the display of said website at said second computer.

2. The method of claim 1 further comprising:
transmitting said code and/or objects from said first computer to said server computer as said code and/or objects is received by said first computer.

3. The method of claim 1 wherein said step of transmitting said code and/or objects of said website by said first computer further comprises:
transmitting said code and/or a link of said objects by said first computer.

4. The method of claim 1 wherein said step of transmitting said code and/or objects of said website by said first computer further comprises:
transmitting a structure of said code and/or objects of said website displayed at said first computer, by said first computer.

5. The method of claim 4 wherein said step of transmitting said code and/or objects of said website by said server computer to a second computer further comprises:
re-creating said code and/or objects of said website displayed at said first computer by said server computer from said structure.

6. The method of claim 1 wherein said first computer further comprising an event changing device; and said method further comprising
tracking the location of said event changing device by said first computer;
transmitting by said first computer to said server computer the location of said event changing device tracked.

7. The method of claim 6 wherein said server computer transmits indicia representative of the location of said event changing device tracked to said second computer.

8. The method of claim 1 further comprising the step of:
communicating between said first computer and said second computer.

9. The method of claim 8 wherein said communicating is by VOIP.

10. The method of claim 8 wherein said communicating is by instant message chat.

11. The method of claim 8 wherein said communicating is by video chat.

12. The method of claim 10 wherein said website is displayed in a window, and said instant message chat is displayed in a separate content block of said window at said second computer.

13. The method of claim 10 wherein said instant message chat is communicated through said server computer.

14. The method of claim 13 wherein said server computer stores said instant message chat, and said code and/or objects of said website.

15. The method of claim 14 further comprising:
sorting and storing said instant message chats by the website associated with the chat.

16. A web browser computer program embodied in a machine readable storage medium for execution by a first computer, said web browser computer program comprising:
computer program code configured to cause the first computer to receive code and/or objects from a website from a network of interconnected computer networks (“Internet”);
computer program code configured to transmit said code and/or objects of said website to a server computer; and
computer program code configured to display said code and/or objects of said website at said first computer.

17. The web browser computer program of claim 16 wherein said computer program code is configured to transmit said code and/or objects to said server computer as said code and/or objects is received by said first computer.

18. The web browser computer program of claim 16 wherein said computer program code is configured to transmit said code and/or a link of said objects to said server computer.

19. The web browser computer program of claim 16 wherein said computer program code is configured to transmit a structure of said code and/or objects of said website displayed at said first computer.

20. The web browser computer program of claim 16 further comprising:
computer program code configured to track the location of an event changing device associated with said first computer; and
computer program code configured to transmit to said server computer the location of said event changing device tracked.

21. The web browser computer program of claim 16 further comprising:
computer program code configured to cause communication between said first computer and another computer connected to the Internet.

22. The web browser computer program of claim 21 wherein said computer program code configured to cause communication causes communication by VOIP.

23. The web browser computer program of claim 21 wherein said computer program code configured to cause communication causes communication by video chat.

24. The web browser computer program of claim 21 wherein said computer program code configured to cause communication causes communication by instant message chat.

25. The web browser computer program of claim 24 wherein said computer program code configured to cause communication further comprises computer program code configured to display and permit activation of pull down menus in a display of instant message chat.

26. An extension computer program for a web browser computer program embodied in a machine readable storage medium for execution by a first computer, said extension computer program comprising:
computer program code configured to cause the first computer to receive code and/or objects from a website from a network of interconnected computer networks (“Internet”);
computer program code configured to transmit said code and/or objects of said website to a server computer; and
computer program code configured in conjunction with the web browser computer program to cause said web browser computer program to display said code and/or objects of said website at said first computer.

27. The extension computer program of claim 26 wherein said computer program code is configured to transmit said code and/or objects to said server computer as said code and/or objects is received by said first computer.

28. The extension computer program of claim 26 wherein said computer program code is configured to transmit said code and/or a link to said objects to said server computer.

29. The extension computer program of claim 26 wherein said computer program code is configured to transmit a structure of said code and/or objects of said website displayed at said first computer.

30. The extension computer program of claim 26 further comprising:
computer program code configured to cause said web browser program to track the location of an event changing device associated with said first computer; and
computer program code configured to transmit to said server computer the location of said event changing device tracked.

31. The extension computer program of claim 26 further comprising:
computer program code configured to cause communication between said first computer and another computer connected to the Internet.

32. The extension computer program of claim 31 wherein said computer program code configured to cause communication causes communication by VOIP.

33. The extension computer program of claim 31 wherein said computer program code configured to cause communication causes communication by video chat.

34. The extension computer program of claim 31 wherein said computer program code configured to cause communication causes communication by instant message chat.

35. The extension computer program of claim 34 wherein said computer program code configured to cause communication further comprises computer program code configured to display and permit activation of pull down menus in a display of instant message chat.

36. A server computer program embodied in a machine readable storage medium for execution by a server computer, said server computer program comprising:
computer program code configured to cause the server computer to receive code and/or objects from a first computer, which received said code and/or objects from a website from a network of interconnected computer networks (“Internet”);
computer program code configured to frame said code and/or objects received in a window; and
computer program code configured to transmit said window to a second computer.

37. The server computer program of claim 36 wherein said computer program code configured to cause the server computer to receive code and/or objects from a first computer further comprises:
computer program code configured to cause the server computer to receive code and/or a link of said objects from a first computer.

38. The server computer program of claim 36 wherein said computer program code configured to cause the server computer to receive code and/or objects from a first computer further comprises:
computer program code configured to cause the server computer to receive a structure of said code and/or objects of said website displayed at said first computer.

39. The server computer program of claim 38 further comprising:
computer program code configured to cause the re-creation of said code and/or objects of said website displayed at said first computer from said structure.

40. The server computer program of claim 36 further comprising:
computer program code configured to receive instant message chat from said first computer; and
computer program code configured to display said instant message chat in a separate content block in said window.

41. The server computer program of claim 36 further comprising:
computer program code configured to store said instant message chat between said first computer and said second computer, and to store said code and/or objects of said website.

42. The server computer program of claim 36 further comprising:
computer program code configured to receive video chat from said first computer; and
computer program code configured to display said video chat in a separate content block in said window.

43. The server computer program of claim 42 further comprising:
computer program code configured to store said video chat between said first computer and said second computer.

44. The server computer program of claim 36 further comprising:
computer program code configured to store VOIP between said first computer and said second computer.

45. The server computer program of claim 41 further comprising:
computer program code configured to sort said instant message chats stored based upon each website associated with said chat.

46. The server computer program of claim 41 wherein said computer program code is configured to compress said code and/or objects received and to transmit said compressed code and/or objects received to said second computer.

47. The server computer program of claim 36 further comprising:
computer program code configured to receive location information of an event changing device associated with said first computer, tracked by said first computer; and
computer program code configured to place indicia representative of the location of said event changing device tracked.

48. A server computer program embodied in a machine readable storage medium for execution by a server computer connected to a network of interconnected computer networks (“Internet”), said server computer program comprising:
computer program code configured to receive instant message chat between a first computer connected to the Internet and for browsing said Internet by accessing a plurality of websites and a second computer, connected to the Internet;
computer program code configured to sort said instant message chats between said first computer and said second computer based upon each website browsed by said first computer; and
computer program code configured to store said sorted instant message chats.

49. A server computer program embodied in a machine readable storage medium for execution by a server computer connected to a network of interconnected computer networks (“Internet”), said server computer program comprising:
computer program code configured to receive instant message chat between a first computer connected to the Internet and for browsing said Internet by accessing a plurality of websites and a second computer, connected to the Internet;
computer program code configured to store said instant message chats between said first computer and said second computer
computer program code configured to retrieve and sort said stored instant message chats based upon each unique website browsed by said first computer.

50. The server computer program of claim 49 further comprising:
computer program code configured to display said instant message chat between said first computer and said second computer in a separate content block of a window; and
computer program code configured to display and permit activation of pull down menus within said separate content block displaying said instant message chat.

51. A method of browsing a website, having code and/or objects, of interest from a network of interconnected networks (“Internet”), wherein said website having program code embodied in a machine readable storage medium for execution by a first computer, embedded in the code and/or objects, said method comprising:
downloading the program code and code and/or objects of the website of interest to the first computer;
executing the program code by the first computer to transmit said code and/or objects of said website of interest to a server computer; and
displaying said code and/or objects of said website of interest at said first computer.

52. The method of claim 51 wherein said program code configured to transmit said code and/or objects of said website of interest to a server computer comprises:
computer program code configured to transmit said code and/or a link of said objects of said website of interest to a server computer.

53. The method of claim 51 wherein said program code configured to transmit said code and/or objects of said website of interest to a server computer comprises:
computer program code configured to transmit a structure of said code and/or objects of said website of interest as displayed by said first computer, to said server computer.

54. The method of claim 51 wherein said program code further comprising:
computer program code configured to track the location of an event changing device associated with said first computer; and
computer program code configured to transmit to said server computer the location of said event changing device tracked.

55. The method of claim 51 wherein said program code further comprising:
computer program code configured to cause communication between said first computer and another computer connected to the Internet.

56. The method of claim 55 wherein said computer program code configured to cause communication causes communication by VOIP.

57. The method of claim 55 wherein said computer program code configured to cause communication causes communication by video chat.

58. The method of claim 55 wherein said computer program code configured to cause communication causes communication by instant message chat.

59. The method of claim 58 wherein said computer program code configured to cause communication further comprises computer program code configured to display and permit activation of pull down menus in a display of instant message chat.
